(19) United States
(12) Patent Application Publication
(10) Pub. No.: US 2005/0143499 A1
(43) Pub. Date: Jun. 30, 2005

(54) Moderately resistive rubber composition and rubber member

(76) Inventors: Hidetoshi Aoki, Yokohama-shi (JP); Naoki Hirakawa, Yokohama-shi (JP); Kazumi Kanai, Yokohama-shi (JP); Mayumi Nakao, Yokohama-shi (JP); Masayoshi Watanabe, Yokohama-shi (JP)

Correspondence Address: HUNTLEY & ASSOCIATES, 1105 NORTH MARKET STREET, P.O. BOX 948, WILMINGTON, DE, 19899-0948, US

(21) Appl. No.: 10/734,021

(22) Filed: Dec. 10, 2003

(51) Int. Cl. C08L 1/00

(52) U.S. Cl. 524/86

(57) ABSTRACT

A moderately resistive rubber composition including an unvulcanized rubber base and at least one ionic liquid contained in the rubber base. In the composition, the ionic liquid serves as an electrically conductive material. Also disclosed is a moderately resistive rubber member formed of a rubber-like elastic material prepared through vulcanization of the moderately resistive rubber composition.

### BACKGROUND OF THE INVENTION

1. Field of the Invention

The present invention relates to a rubber composition and a rubber member which exhibit moderate electrical resistance, and more particularly to a moderately resistive rubber composition and a moderately resistive rubber member which are suitable for use for smoothing charges on, eliminating charges from, or imparting charges to, for example, an electrophotographic sensitive member; a transfer drum or a transfer belt, which is employed in a transfer process; an intermediate transport belt; or a developing blade, a developing roll, or a charge-imparting roll, which is employed in a developing process.

2. Background Art

A variety of moderately resistive rubber members are employed in electrophotographic apparatuses and electrostatic recording apparatuses, such as copying machines and laser printers, in order to smooth charges on, eliminate charges from, or impart charges to parts incorporated into such apparatuses.

Such a moderately resistive rubber member is formed by adding an electrically conductive material to a rubber base material such as polyurethane or epichlorohydrin rubber, and has a predetermined electrical resistance. Moderately resistive rubber members known hitherto include an electron-conducting-type rubber member containing an electrically conductive material such as electrically conductive carbon black; an ion-conducting-type rubber member containing an alkali metal salt such as lithium perchlorate (see, for example, Japanese Patent Application Laid-Open (kokai) No. 5-173409 (e.g., paragraphs [0014] and [0025]), Japanese Patent Application Laid-Open (kokai) No. 5-281831 (e.g., paragraphs [0018] and [0028]), Japanese Patent Application Laid-Open (kokai) No. 10-045953 (e.g., claims), and Japanese Patent Application Laid-Open (kokai) No. 10-039582 (claims)); and a hybrid-type rubber member containing both an electrically conductive material and an alkali metal salt (see, for example, Japanese Patent Application Laid-Open (kokai) No. 6-035298 (claims), Japanese Patent Application Laid-Open (kokai) No. 8-179592 (claims), and Japanese Patent Application Laid-Open (kokai) No. 2000-214659 (e.g., paragraphs [0032] through [0035])).

Of these moderately resistive rubber members, an electron-conducting-type rubber member involves a problem in that difficulty is encountered in reliably attaining a target moderate electrical resistance. Meanwhile, an ion-conducting-type rubber member involves problems in that its resistance varies in accordance with change in temperature, humidity, and voltage applied to the rubber member, and that handling an ion-conducting material such as lithium perchlorate involves risk.

### SUMMARY OF THE INVENTION

In view of the foregoing, an object of the present invention is to provide a moderately resistive rubber composition which can reliably attain a target resistance. Another object of the present invention is to provide a rubber member which can reliably attain a target resistance.

According to a first mode of the present invention for solving the aforementioned problems, there is provided a moderately resistive rubber composition comprising an unvulcanized rubber base and at least one ionic liquid contained in the rubber base, the ionic liquid serving as an electrically conductive material.

In a second mode of the present invention, which is drawn to a specific embodiment of the moderately resistive rubber composition according to the first mode, the ionic liquid contains a cationic species selected from the group consisting of cationic species represented by the following formulas (1) through (4): 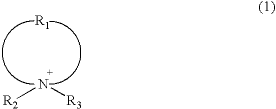
(wherein R₁ represents a C4-C10 hydrocarbon group; each of R₂ and R₃ represents a hydrogen atom, or a C1-C8 alkyl group; which R₁, R₂ or R₃ may contain a hetero atom; and, when the nitrogen atom has a double bond, R₃ is absent); 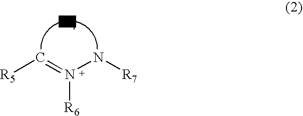
(wherein R₄ represents a C2-C10 hydrocarbon group, and each of R₅, R₆, and R₇ represents a hydrogen atom, or a C1-C8 alkyl group, which R₄, R₅, R₆ or R₇ may contain a hetero atom); 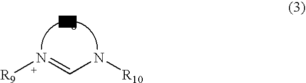
(wherein R₈ represents a C2-C10 hydrocarbon group, and each of R₉ and R₁₀ represents a hydrogen atom, or a C1-C8 alkyl group, which R₈, R₉, or R₁₀ may contain a hetero atom); and 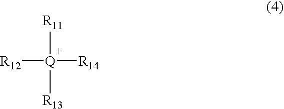
(wherein Q represents a nitrogen atom, a phosphorus atom, or a sulfur atom; each of R₁₁, R₁₂, R₁₃, and R₁₄ represents a hydrogen atom, or a C1-C8 alkyl group, which R₁₁, R₁₂, R₁₃ or R₁₄ may contain a hetero atom; and, when Q is a sulfur atom, R₁₁ is absent)

In a third mode of the present invention, which is drawn to a specific embodiment of the moderately resistive rubber composition according to the first or second mode, the ionic liquid contains an anionic species selected from among AlCl₄⁻, Al₂Cl₇⁻, NO₃⁻, BF₄⁻, PF₆⁻, CH₃COO⁻, CF₃COO⁻, CF₃SO₃⁻, (CF₃SO₂)₂N⁻, (CF₃SO₂)₃C⁻, AsF₆⁻, SbF₆⁻, F(HF)ₙ⁻, CF₃CF₂CF₂CF₂SO₃⁻, (CF₃CF₂SO₂)₂N⁻, and CF₃CF₂CF₂COO⁻.

In a fourth mode of the present invention, which is-drawn to a specific embodiment of the moderately resistive rubber composition according to any of the first through third modes, the ionic liquid has a melting point of 70° C. or less.

In a fifth mode of the present invention, which is drawn to a specific embodiment of the moderately resistive rubber composition according to any of the first through fourth modes, the volume resistivity of the rubber composition is 1×10³ to 1×10⁹ Ω·cm.

According to a sixth mode of the present invention, there is provided a moderately resistive rubber member comprising a rubber-like elastic material formed through vulcanization of the moderately resistive rubber composition as recited in any of the first through fifth modes.

Since the moderately resistive rubber composition of the present invention contains an ionic liquid as an electrically conductive material, the rubber composition and the moderately resistive rubber member, which contains the rubber composition, can reliably attain a target resistance.

As used herein, the term “ionic liquid” refers to a salt which is in the liquid state at room temperature (may be called “ambient temperature molten salt”), and particularly to a salt having a melting point of 70° C. or less, preferably 30° C. or less. Such an ionic liquid has no vapor pressure (non-volatility), exhibits high thermal resistance and incombustibility, and is chemically stable.

Therefore, unlike the case of an ion-conducting material, an ionic liquid involves low risk of handling. Since an ionic liquid does not require employment of a solvent, addition of the ionic liquid to a rubber base is readily carried out, and the resultant rubber composition can readily attain a target moderate resistance. Since an ionic liquid has no volatility, when the ionic liquid exhibits compatibility with a rubber base, bleeding of the ionic liquid does not occur. Particularly when a water-insoluble ionic liquid (hydrophobic ionic liquid) is employed, the resultant rubber composition is considered to be minimally affected by changes in humidity and to provide consistent electrical conductivity. Unlike the case of carbon black, an ionic liquid does not impart a black color to the rubber composition, and thus the rubber composition can be formed into a moderately resistive rubber member of a whitish color or any color, as desired.

The ionic liquid which may be employed in the present invention contains an organic cationic species represented by any of formulas (1) through (4); for example, a cyclic amidine ion such as an imidazolium ion, a pyridinium ion, an ammonium ion, a sulfonium ion, or a phosphonium ion. Examples of the anionic species constituting the ionic liquid include AlCl₄⁻, Al₂Cl₇⁻, NO₃⁻, BF₄⁻, PF₆⁻, CH₃COO⁻, CF₃COO⁻, CF₃SO₃⁻, (CF₃SO₂)₂N⁻, (CF₃SO₂)₃C⁻, AsF₆⁻, SbF₆⁻, F(HF)ₙ⁻, CF₃CF₂CF₂CF₂SO₃⁻, (CF₃CF₂SO₂)₂N⁻, and CF₃CF₂CF₂COO⁻.

Specific examples of the ionic liquid include compounds formed by combining the below-described organic cationic species and counter anionic species.

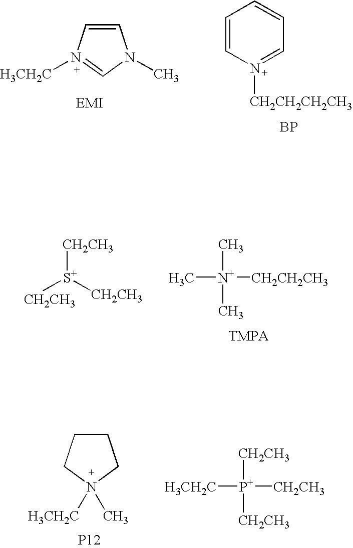

Description of abbreviation
EMI: 1-ethyl-3-methylimidazole
BP: 1-butylpyridine
P12: N-ethyl-N-methylpyrrolidine

TMPA: Trimethylpropylamine

| | |
|---|---|
| BF₄⁻ | CH₃COO⁻ |
| NO₃⁻ | CF₃COO⁻ |
| PF₆⁻ | CF₃SO₃⁻: TI |
| AlCl₄⁻ | (CF₃SO₂)₂N⁻: TFSI |
| Al₂Cl₇⁻ | (CF₃SO₂)₃C⁻: TFSM |

Description of abbreviation
TFSI: bis{(trifluoromethyl)sulfonyl}imide

No particular limitations are imposed on the ionic liquid employed in the present invention, so long as it exhibits compatibility with unvulcanized rubber (crude rubber) serving as a base material.

Some ionic liquids are insoluble in water. In the rubber composition of the present invention, preferably, a water-insoluble ionic liquid (hydrophobic ionic liquid) is employed, in consideration of, for example, stability of the composition with respect to moisture, and corrosion of metal contained in, for example, a metallic core, which would be caused by the composition.

No particular limitations are imposed on the material of an unvulcanized rubber base and a rubber-like elastic material formed through cross-linking of the rubber base. Examples of the material include epichlorohydrin series such as epichlorohydrin rubber, ethylene oxide epichlorohydrin copolymer(ECO), epichlorohydrin-allyl glycidyl ether copolymer and epichlorohydrin-ethylene oxide-allyl glycidyl ether copolymer; acrylonitrile butadiene rubber (NBR); urethane rubber (U); and chloroprene rubber (CR). In particular, from the viewpoint of compatibility with the ionic liquid, the rubber material preferably has a solubility parameter (SP value) of 9.0 or more. When the rubber composition is formed into a member which is brought into direct contact with a photosensitive member, in consideration of contamination of the photosensitive member, polyurethane or epichlorohydrin series is preferably employed in the rubber composition.

The volume resistivity required for the moderately resistive rubber composition or rubber member of the present invention differs depending on its use. For example, the volume resistivity of the rubber composition or rubber member may be about 1×10³ to about 1×10⁹ Ω·cm. In order to attain such a preferred resistivity, the type and amount of the ionic liquid to be added are determined appropriately.

A characteristic feature of the moderately resistive rubber composition of the present invention resides in that it exhibits, even when being not vulcanized, consistent volume resistivity, and the volume resistivity is not considerably changed with passage of time. Therefore, the rubber composition containing an ionic liquid can be transported even in an unvulcanized state.

The moderately resistive rubber composition of the present invention can be appropriately subjected to vulcanization and molding by means of a predetermined technique, to thereby form a moderately resistive rubber member. In accordance with the rubber base material employed in the composition, the vulcanization technique is appropriately selected from among generally employed vulcanization techniques, such as sulfur vulcanization and peroxide vulcanization.

The thus-formed moderately resistive rubber member may assume any of a block shape, a roller shape, and a blade shape. The rubber member having a blade shape may be disposed such that the edge of the blade faces toward the direction of motion of a counterpart element, or such that the edge of the blade faces away from the direction of motion of the counterpart element.

The moderately resistive rubber member of the present invention may contain an electron-conducting material such as carbon black or metallic powder, or an ion-conducting-material such as lithium perchlorate, so long as such an additive does not impede the purposes of the present invention.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with an accompanying drawings, in which:

FIG. 1 is a graph showing the results of Test Example 1 employing an ECO base;

FIG. 2 is a graph showing the results of Test Example 1 employing an NBR base;

FIG. 3 is a graph showing the results of Test Example 1 employing a urethane (U) rubber base;

FIG. 4 is a graph showing the results of Test Example 2;

FIG. 5 is a graph showing the results of Test Example 3 employing an ECO base;

FIG. 6 is a graph showing the results of Test Example 3 employing an NBR base;

FIG. 7 is a graph showing the results of Test Example 3 employing a urethane (U) rubber base;

FIG. 8 is a graph showing the results of Test Example 3, where different ionic liquids were used;

FIG. 9 is a graph showing the results of Test Example 4 employing an ECO base;

FIG. 10 is a graph showing the results of Test Example 4 employing an NBR base;

FIG. 11 is a graph showing the results of Test Example 4 employing a urethane (U) rubber base;

FIG. 12 is a graph showing the results of Test Example 5 employing an ECO base;

FIG. 13 is a graph showing the results of Test Example 5 employing an NBR base;

FIG. 14 is a graph showing the results of Test Example 5 employing a urethane (U) rubber base; and

FIG. 15 is a graph showing the results of Test Example 7.

### DETAILED DESCRIPTION OF PREFERRED EMBODIMENTS

The present invention will next be described by way of Examples, which should not be construed as limiting the invention thereto.

### EXAMPLES 1 THROUGH 5

1-Ethyl-3-methylimidazolium bis(trifluoromethylsulfonyl)imide (EMITFSI) was employed as an ionic liquid. EMITFSI (0.1 parts by weight, 1 part by weight, 5 parts by weight, 10 parts by weight, or 20 parts by weight) was added to and kneaded with an ethylene oxide epichlorohydrin copolymer(ECO) base (100 parts by weight), and the resultant mixture was subjected to vulcanization at 160° C. for 20 minutes, followed by pressing, to thereby produce a plate (size: 120 mm×120 mm, thickness: 1.0 mm).

### EXAMPLES 6 THROUGH 10

The procedure of Examples 1 through 5 was repeated, except that an acrylonitrile-butadiene rubber (NBR) base was employed in place of the ECO base, to thereby produce a plate.

### EXAMPLES 11 THROUGH 15

1-Ethyl-3-methylimidazolium bis(trifluoromethylsulfonyl)imide (EMITFSI) was employed as an ionic liquid. EMITFSI (0.5 parts by weight, 1 part by weight, 3 parts by weight, 5 parts by weight, or 10 parts by weight) was added to an ester series polyol (100 parts by weight). In addition, a chain-extending agent, a cross-linking agent, and an isocyanate were added to the resultant mixture, to thereby allow reaction to proceed. A plate (size: 120 mm×120 mm, thickness: 1.0 mm) was produced from the resultant reaction mixture.

### EXAMPLE 16

The procedure of Example 1 was repeated, except that 1-butyl-3-methylimidazolium bis(trifluoromethylsulfonyl)imide (BMITFSI) (5 parts by weight) was employed in place of EMITFSI, to thereby produce a plate.

### EXAMPLE 17

The procedure of Example 1 was repeated, except that 1-butylpyridinium bis(trifluoromethylsulfonyl)imide (BPTFSI) (5 parts by weight) was employed in place of EMITFSI, to thereby produce a plate.

### EXAMPLE 18

The procedure of Example 1 was repeated, except that N-butyl-N-methylpyrrolidinium bis(trifluoromethylsulfonyl)imide (P₁₄TFSI) (5 parts by weight) was employed in place of EMITFSI, to thereby produce a plate.

### EXAMPLE 19

The procedure of Example 1 was repeated, except that 1-ethyl-3-methylimidazolium tetrafluoroborate (EMIBF₄) (5 parts by weight) was employed in place of EMITFSI, to thereby produce a plate.

### EXAMPLE 20

The procedure of Example 1 was repeated, except that 1-ethyl-3-methylimidazolium tetrafluoroborate (EMIBF₄) (3 parts by weight) was employed in place of EMITFSI, and an acrylonitrile-butadiene rubber (NBR) base was employed in place of the ECO base, to thereby produce a plate.

### COMPARATIVE EXAMPLE 1

The procedure of Example 1 was repeated, except that EMITFSI was not added, to thereby produce a plate for comparison.

### COMPARATIVE EXAMPLE 2

The procedure of Example 6 was repeated, except that EMITFSI was not added, to thereby produce a plate.

### COMPARATIVE EXAMPLE 3

The procedure of Example 11 was repeated, except that EMITFSI was not added, to thereby produce a plate.

### COMPARATIVE EXAMPLES 4 THROUGH 9

The procedure of Example 1 (ECO) was repeated, except that carbon black (0.1 parts by weight, 1 part by weight, 5 parts by weight, 10 parts by weight, 15 parts by weight, or 20 parts by weight) was added in place of EMITFSI, to thereby produce a plate.

### COMPARATIVE EXAMPLES 10 THROUGH 14

The procedure of Example 1 was repeated, except that sodium trifluoroacetate (0.1 parts by weight, 1 part by weight, 5 parts by weight, 10 parts by weight, or 20 parts by weight) was added in place of EMITFSI, to thereby produce a plate.

### COMPARATIVE EXAMPLES 15 THROUGH 20

The procedure of Example 6 (NBR) was repeated, except that carbon black (0.1 parts by weight, 1 part by weight, 5 parts by weight, 10 parts by weight, 15 parts by weight, or 20 parts by weight) was added in place of EMITFSI, to thereby produce a plate.

### COMPARATIVE EXAMPLES 21 THROUGH 25

The procedure of Example 6 (NBR) was repeated, except that sodium trifluoroacetate (0.1 parts by weight, 1 part by weight, 5 parts by weight, 10 parts by weight, or 20 parts by weight) was added in place of EMITFSI, to thereby produce a plate.

### COMPARATIVE EXAMPLES 26 AND 27

The procedure of Example 11 (U) was repeated, except that carbon black (0.5 parts by weight or 1 part by weight) was added in place of EMITFSI, to thereby produce a plate.

### COMPARATIVE EXAMPLE 28

The procedure of Example 11 (U) was repeated, except that lithium perchlorate (3 parts by weight) was added in place of EMITFSI, to thereby produce a plate.

### TEST EXAMPLE 1

Each of the plates of Examples 1 through 15 and Comparative Examples 1 through 27 was subjected to measurement of volume resistivity under conditions of ambient temperature and ambient humidity (temperature: 23° C., relative humidity: 50%). For measurement of the volume resistivity, the plate (test piece) was allowed to stand in a chamber under the above conditions for a predetermined time, and subsequently, by use of brass-made electrodes and a current measuring apparatus, a DC voltage of 100 V was applied to the test piece and the current after one-minute charging was measured, by means of the method specified by JIS K6723. The volume resistivity was calculated from the following formula: ρ=(πd²/4t)Rv (ρ: volume resistivity (Ω·cm), d: diameter of main electrode (cm), t: thickness of test piece (cm), Rv: volume resistance (Ω)). In this test, there were employed a main electrode having a diameter of 50 mm and a height of 35 mm, a guard electrode having an outer diameter of 80 mm, an inner diameter of 70 mm, and a height of 10 mm, and a counter electrode having a size of 300 mm×150 mm×2 mm.

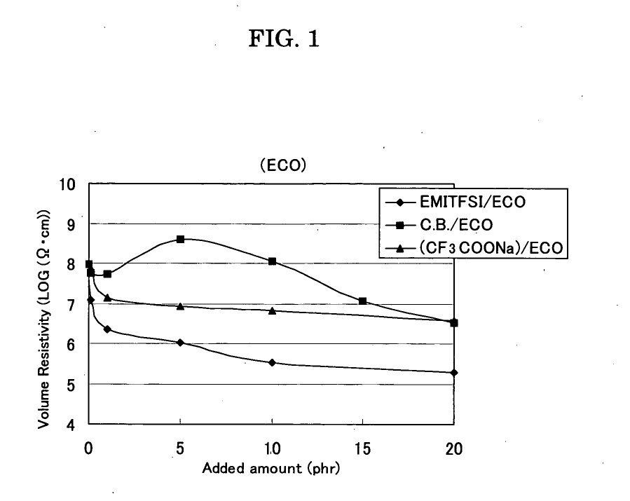

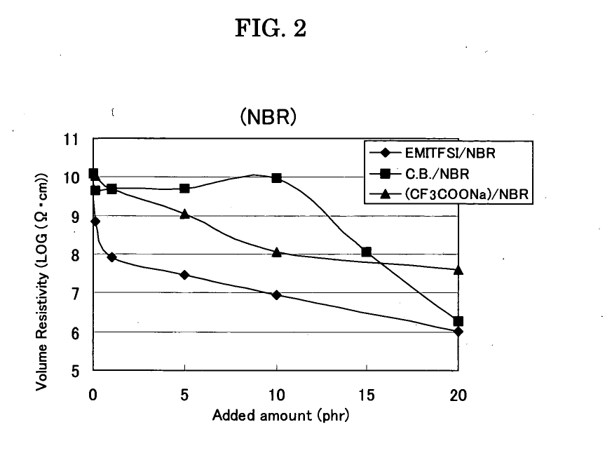

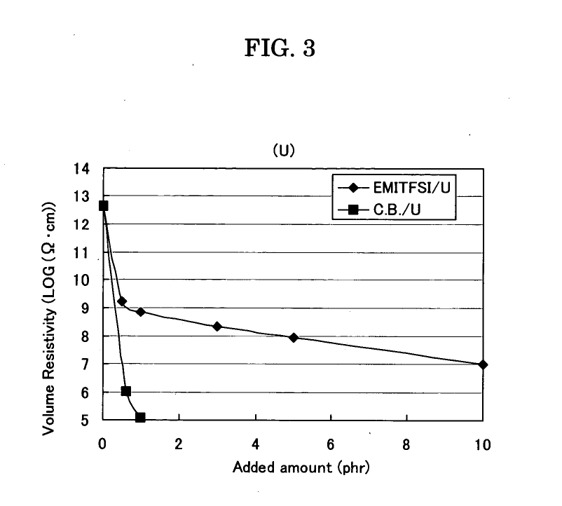

The results are shown in FIGS. 1 through 3.

As is clear from FIGS. 1 through 3, in each of the plates of the Examples, in which the ionic liquid is employed, the volume resistivity (logarithmic value) gradually decreases in accordance with an increase in the amount of the ionic liquid, and thus a target resistance is readily attained. In contrast, in each of the plates of the Comparative Examples in which carbon black is employed, the volume resistivity does not decrease until the amount of the carbon black reaches a certain level, and when the carbon black content becomes higher than the level, the volume resistivity drops drastically. Meanwhile, in each of the plates of the Comparative Examples in which an alkali metal salt was employed, the volume resistivity gradually decreased in accordance with an increase in the amount of the alkali metal salt, as in the case of the plates of the Examples, in which the ionic liquid was employed, but the degree of decrease in the volume resistivity was low. In addition, when the rubber plate containing the alkali metal salt in an amount of parts by weight or more was allowed to stand for several days, blooming occurred in the plate. As described above, in each of the plates of the Examples, in which the ionic liquid is employed, the volume resistivity decreases even when the ionic liquid content is low, and a target resistance is more readily attained as compared with the case of the Comparative Examples in which the carbon black is employed or the Comparative Examples in which the alkali metal salt is employed. Since the ionic liquid exhibits good compatibility with the rubber base, blooming- and bleeding, which may occur in the plate containing the alkali metal salt, do not occur in the plates of the Examples.

### TEST EXAMPLE 2

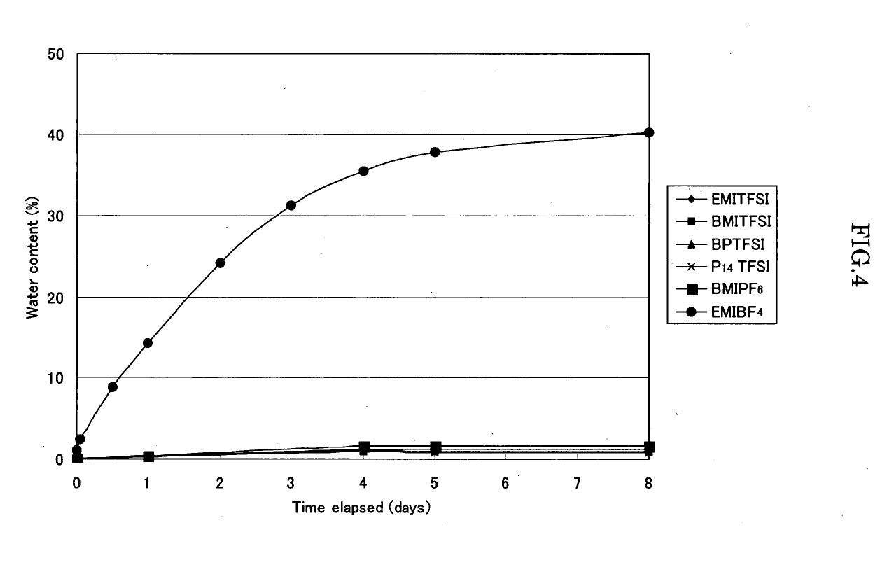

The above-employed ionic liquids were subjected to measurement of water content by means of the Karl-Fischer method. Specifically, each of the ionic liquids was allowed to stand under conditions of high temperature and high humidity (temperature: 35° C., humidity: 85%), and the water content of the ionic liquid was measured at predetermined day intervals, whereby the saturated water content was determined. The results are shown in FIG. 4.

As is clear from FIG. 4, the saturated water content of a hydrophobic ionic liquid is about 1.5%, and the saturated water content of EMIBF₄, which is a water-soluble ionic liquid (hydrophilic ionic liquid), is 30% or more. The results reveal that when the hydrophilic ionic liquid is allowed to stand under conditions of high temperature and high humidity, the ionic liquid absorbs moisture. The results imply that the rubber containing the hydrophilic ionic liquid may promote oxidation of metal contained in a metallic core, dies, etc.

### TEST EXAMPLE 3

Each of the plates of Examples 3, 4, 9, 14, and 16 through 19 and Comparative Examples 1, 8, 14, 20, 25, 26, and 28 was allowed to stand for five hours under the following conditions: temperature: 35° C., relative humidity: 30% to 80%, and the volume resistivity of the resultant plate was measured in a manner similar to that described above.

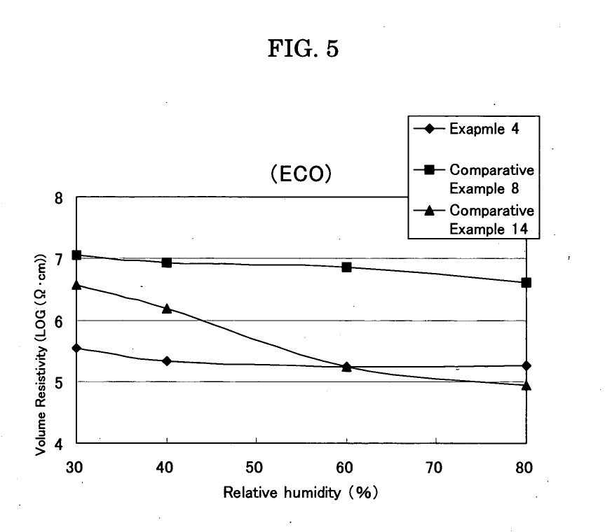

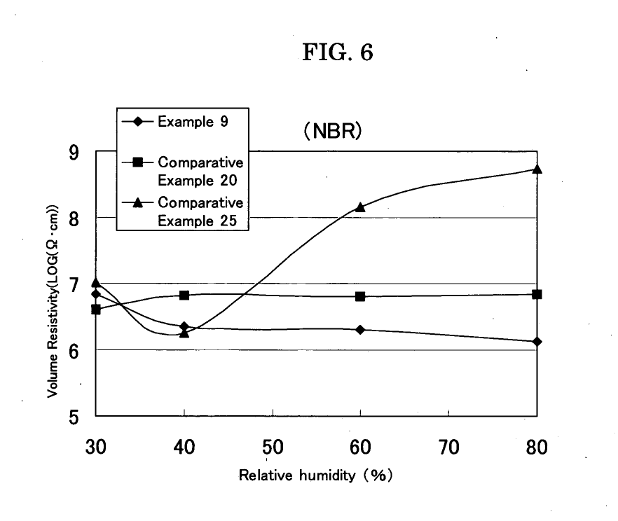

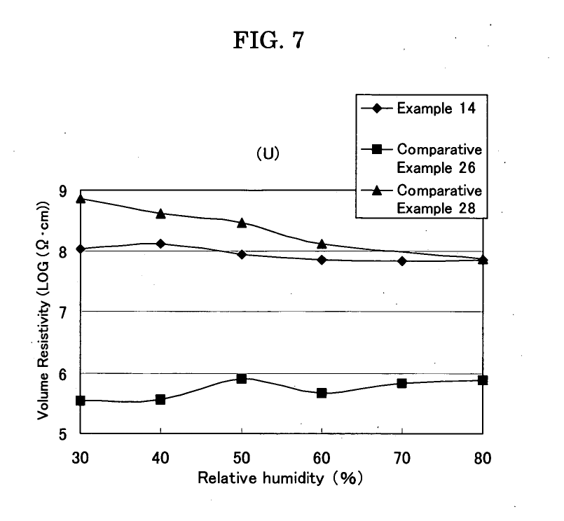

The results are shown in FIGS. 5 through 8.

As is clear from FIGS. 5 through 8, regardless of the rubber base material, the plate containing an ionic liquid is minimally affected by humidity changes, as compared with the case of the plate containing an alkali metal salt.

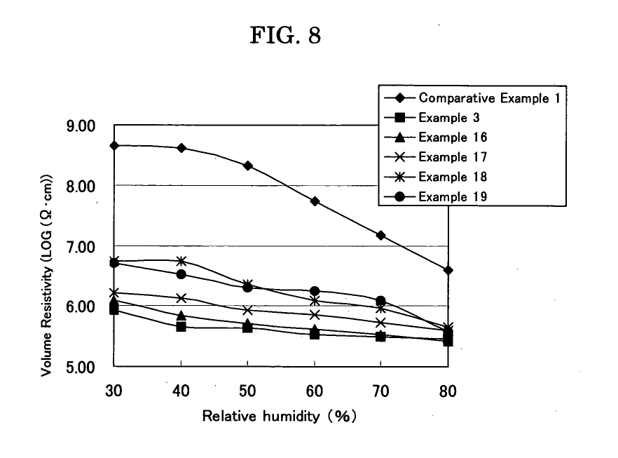

As is clear from FIG. 8, the plate containing an ionic liquid is minimally affected by changes in humidity and such a tendency does not depend on the type of the ionic liquid, and the plate of Example 19, which contains the hydrophilic ionic liquid, is also minimally affected by changes in humidity.

In the cases of Example 19 (ECO base) and Example 20 (NBR base), in which the hydrophilic ionic liquid was employed, generation of a small amount of rust was observed in the roll employed for kneading the rubber composition.

### TEST EXAMPLE 4

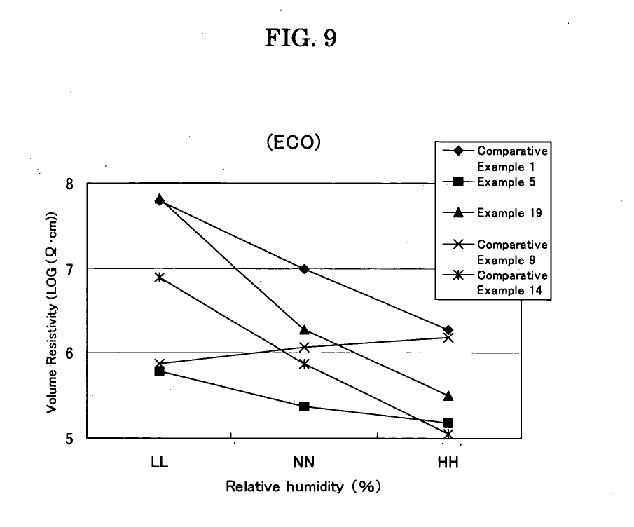

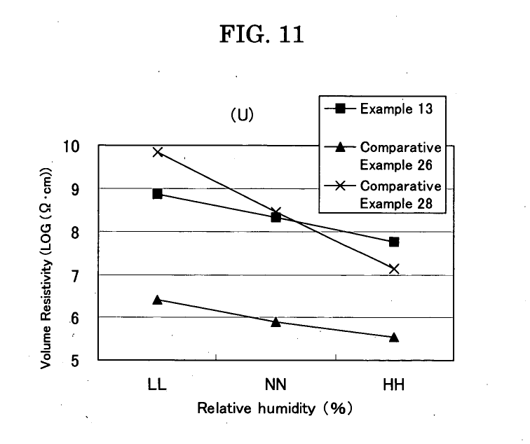

The volume resistivity of each of the plates of Examples 5, 9, 13, 19, and 20 and Comparative Examples 1, 2, 9, 14, 19, 25, 26, and 28 was measured in a manner similar to that described above under the following conditions: conditions of low temperature and low humidity (LL, temperature: 10° C., relative humidity: 20%), conditions of ambient temperature and ambient humidity (NN, temperature: 25° C., relative humidity: 50%), and conditions of high temperature and high humidity (HH, temperature: 35° C., relative humidity: 85%). The results are shown in FIGS. 9 through 11.

As is clear from FIGS. 9 through 11, the plate containing the ECO or U rubber base material and the hydrophobic ionic liquid is minimally affected by change in environmental conditions, as compared with the case of the plate containing the ECO or U rubber base material and the alkali metal salt.

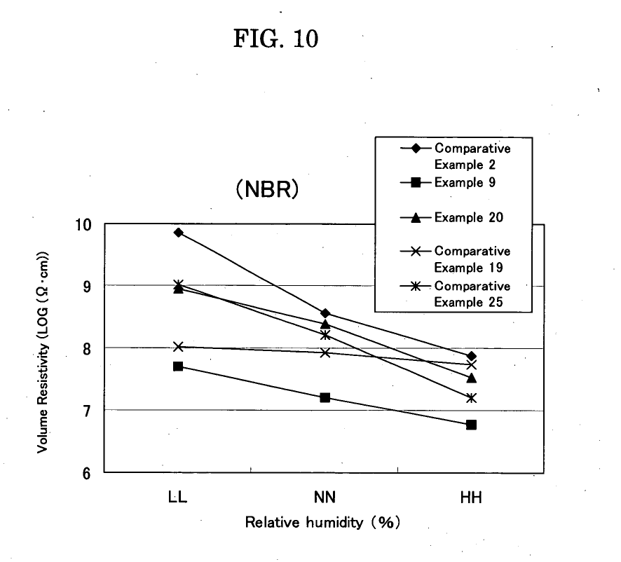

As shown in FIG. 9, when the ECO rubber base material is employed, the plate containing the hydrophilic ionic liquid is considerably affected by change in environmental conditions, as in the case of the plate containing the alkali metal salt. In contrast, as shown in FIG. 10, when the NBR rubber base material is employed, the plate containing the hydrophilic ionic liquid exhibits environmental dependency comparable to that of the plate containing the hydrophobic ionic liquid.

In the case of the plate containing the NBR rubber base material and the alkali metal salt, when the conditions were changed from LL to NN and HH, blooming of the alkali metal salt occurred on the surface of the plate, and the volume resistivity of the plate was not accurately measured.

### TEST EXAMPLE 5

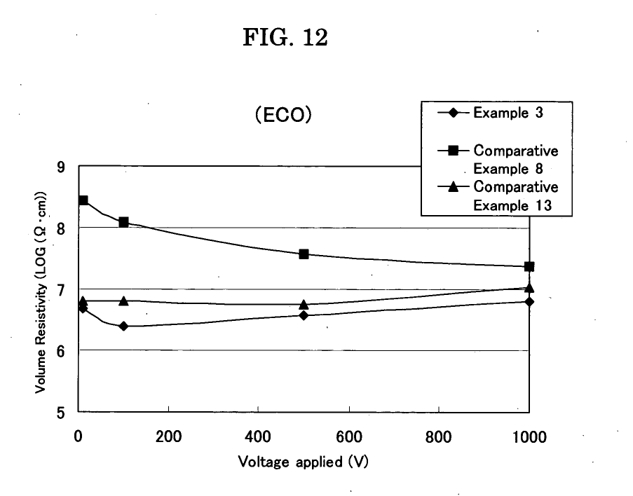

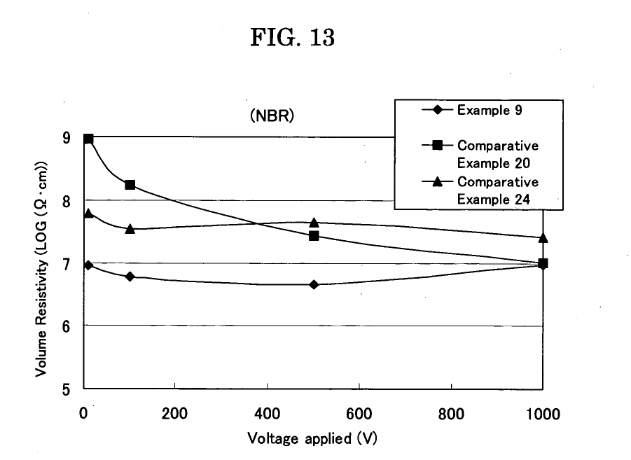

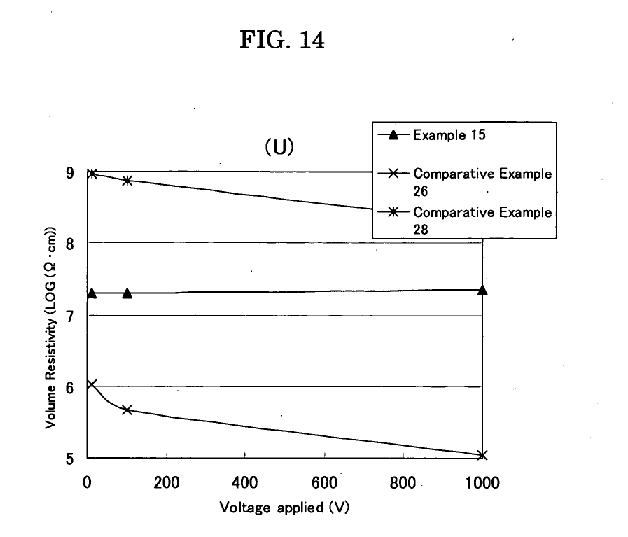

The volume resistivity of each of the plates of Examples 3, 9, and 15 and Comparative Examples 8, 13, 20, 24, 26, and 28 was measured in a manner similar to that described above under conditions of ambient temperature and ambient humidity (temperature: 23° C., relative humidity: 50%), while a voltage to be applied was varied from 10 V to 1,000 V. The results are shown in FIGS. 12 through 14.

As is clear from FIGS. 12 through 14, regardless of the rubber base material, the plate containing the ionic liquid is minimally affected by change in voltage, as compared with the case of the plate containing carbon black.

### TEST EXAMPLE 6

Each of the plates of Examples 1 through 15 and Comparative Examples 1 through 7 and 9 through 28 was subjected to measurement of hardness (Hs) (JIS K6253 type A), rebound resilience (Rb) (JIS K6255), tensile strength (Tb) and elongation at break (Eb) (JIS K6251), tear strength (Tr) (JIS K6252), and compression set (Cs). The results are shown in Tables 1 through 3.

TABLE 1

| | | | | Rebound | Tear | Compressio [symbol] |
|---|---|---|---|---|---|---|
| ECO | | | Hardness Hs | resilience | strength Tr | Cs |
| | Additive | phr | (JIS A)° | Rb % | N/mm | (70° C. 22 [symbol] % |
| Comp. Ex. 1 | None | | 47 | 80 | 17.5 | 12 |
| Ex. 1 | EMITFSI | 0.1 | 45 | 78 | 15.3 | 11.3 |
| Ex. 2 | | 1 | 45 | 78 | 14.7 | 11 |
| Ex. 3 | | 5 | 43 | 78 | 12.3 | 10.9 |
| Ex. 4 | | 10 | 41 | 78 | 11.5 | 12.5 |
| Ex. 5 | | 20 | 39 | 78 | 10.8 | 12.1 |
| Comp. Ex. 4 | C.B. | 0.1 | 47 | 78 | 17.4 | 14.01 |
| Comp. Ex. 5 | | 1 | 47 | 78 | 18.9 | 13 |
| Comp. Ex. 6 | | 5 | 50 | 78 | 29.3 | 14.6 |
| Comp. Ex. 7 | | 10 | 53 | 75 | 35.8 | 17 |
| Comp. Ex. 9 | | 20 | 60 | 66 | 50.7 | 20.3 |
| Comp. Ex. 10 | Sodium | 0.1 | 46 | 78 | 14.8 | 13 |
| Comp. Ex. 11 | trifluoro- | 1 | 46 | 79 | 11.8 | 10.6 |
| Comp. Ex. 12 | acetate | 5 | 47 | 78 | 11.6 | 13 |
| Comp. Ex. 13 | | 10 | 46 | 70 | 8.7 | 17 |
| Comp. Ex. 14 | | 20 | 44 | 59 | 6.9 | 18.2 |

TABLE 2

| | | | | Rebound | Tear | Compressio [symbol] |
|---|---|---|---|---|---|---|
| NBR | | | Hardness Hs | resilience | strength Tr | Cs |
| | Additive | phr | (JIS A)° | Rb % | N/mm | (70° C. 22 [symbol] % |
| Comp. Ex. 2 | None | | 46 | 52 | 20.1 | 21 |
| Ex. 6 | EMITFSI | 0.1 | 47 | 51 | 20.8 | 22 |
| Ex. 7 | | 1 | 47 | 51 | 20.8 | 21 |
| Ex. 8 | | 5 | 48 | 53 | 19.6 | 20 |
| Ex. 9 | | 10 | 46 | 55 | 18.0 | 14 |
| Ex. 10 | | 20 | 43 | 55 | 16.1 | 19 |
| Comp. Ex. 15 | C.B. | 0.1 | 47 | 52 | 20.0 | 21 |
| Comp. Ex. 16 | | 1 | 49 | 52 | 21.5 | 20 |
| Comp. Ex. 17 | | 5 | 53 | 50 | 24.6 | 18 |
| Comp. Ex. 18 | | 10 | 55 | 48 | 27.8 | 18 |
| Comp .Ex. 19 | | 15 | 57 | 45 | — | 19 |
| Comp. Ex. 20 | | 20 | 60 | 44 | 36.9 | 19 |
| Comp. Ex. 21 | Sodium | 0.1 | 46 | 52 | 16.7 | 28 |
| Comp. Ex. 22 | trifluoro- | 1 | 48 | 52 | 14.7 | 25 |
| Comp. Ex. 23 | acetate | 5 | 45 | 51 | 16.9 | 24 |
| Comp. Ex. 24 | | 10 | 47 | 42 | 16.1 | 27 |
| Comp. Ex. 25 | | 20 | 46 | 41 | 13.7 | 25 |

TABLE 3

| | | | Hardness | Rebound | Tensile strength | |
|---|---|---|---|---|---|---|
| U | | | Hs | resilience | Tb | Elong [symbol] |
| | Additive | phr | (JIS A)° | Rb % | MPa | E [symbol] % |
| Comp. Ex. 3 | None | | 73 | 45 | 36.4 | 35 [symbol] |
| Ex. 11 | EMITFSI | 0.5 | 73 | 47 | 42.1 | 38 [symbol] |
| Ex. 12 | | 1 | 73 | 48 | 41.2 | 39 [symbol] |
| Ex. 13 | | 3 | 71 | 47 | 44.5 | 41 [symbol] |
| Ex. 14 | | 5 | 72 | 48 | 43.5 | 36 [symbol] |
| Ex. 15 | | 10 | 70 | 52 | 45.4 | 43 [symbol] |
| Comp. Ex. 26 | C.B. | 0.5 | 77 | 42 | 42 | 33 [symbol] |
| Comp. Ex. 27 | | 1 | 80 | 40 | 46 | 39 [symbol] |
| Comp. Ex. 28 | LiClO₄ | 3 | 72 | 29 | 58.7 | 38 [symbol] |

As is clear from Tables 1 through 3, in the case of the plates of the Comparative Examples in which carbon black is employed, regardless of the rubber base material, the hardness greatly increases in accordance with an increase in the amount of the carbon black, and accordingly, the tensile strength increases. In the case of the plates of the Comparative Examples in which an alkali metal salt is employed, regardless of the rubber base material, the rebound resilience decreases in accordance with an increase in the amount of the alkali metal salt. Meanwhile, each of the plates of the Examples containing the ionic liquid in an amount of 10 phr (parts per rubber) or less exhibits physical properties comparable to those of the plate containing no ionic liquid.

### EXAMPLES 21 THROUGH 23

1-Ethyl-3-methylimidazolium bis(trifluoromethylsulfonyl)imide (EMITFSI) was employed as an ionic liquid. EMITFSI (1 part by weight, 5 parts by weight, or 20 parts by weight) was added to and kneaded with an ethylene oxide epichlorohydrin copolymer(ECO) base (100 parts by weight), to thereby prepare a moderately resistive rubber composition.

### EXAMPLES 24 THROUGH 26

The procedure of Examples 21 through 23 was repeated, except that an acrylonitrile-butadiene rubber (NBR) base was employed in place of the ECO base, to thereby prepare a moderately resistive rubber composition.

### EXAMPLES 27 THROUGH 30

The procedure of Examples 21 through 23 was repeated, except that a polyol serving as a raw material of urethane rubber was employed in place of the ECO base, and EMITFSI (1 part by weight, 5 parts by weight, 10 parts by weight, or 20 parts by weight) was added to the polyol, to thereby prepare a moderately resistive rubber composition.

### COMPARATIVE EXAMPLE 29

The procedure of Example 21 was repeated, except that EMITFSI was not added, to thereby prepare a moderately resistive rubber composition for comparison.

### COMPARATIVE EXAMPLE 30

The procedure of Example 24 was repeated, except that EMITFSI was not added, to thereby prepare a moderately resistive rubber composition.

### COMPARATIVE EXAMPLE 31

The procedure of Example 27 was repeated, except that EMITFSI was not added, to thereby prepare a moderately resistive rubber composition.

### TEST EXAMPLE 7

In a manner similar to that of Test Example 1, each of the moderately resistive rubber compositions (unvulcanized rubber compositions) of Examples 21 through 30 and Comparative Examples 29 through 31 was subjected to measurement of volume resistivity under conditions of ambient temperature and ambient humidity (temperature: 25° C., relative humidity: 50%).

For measurement of the volume resistivity of each of the rubber compositions of Examples 21 through 26 and Comparative Examples 29 and 30 (rubber base: ECO and NBR), a plate having a thickness of 1 mm was formed from the rubber composition, and the volume resistivity of the plate was measured in a manner similar to that of Test Example 1. Meanwhile, in the case of each of the rubber compositions of Examples 27 through 30 and Comparative Example 31 (rubber base: polyol), which is in the form of liquid, electrodes (size: 10 mm×18 mm) were inserted in the composition at an interval of 8 mm, and a DC voltage of 100 V was applied to the electrodes, whereby the volume resistivity of the composition was measured.

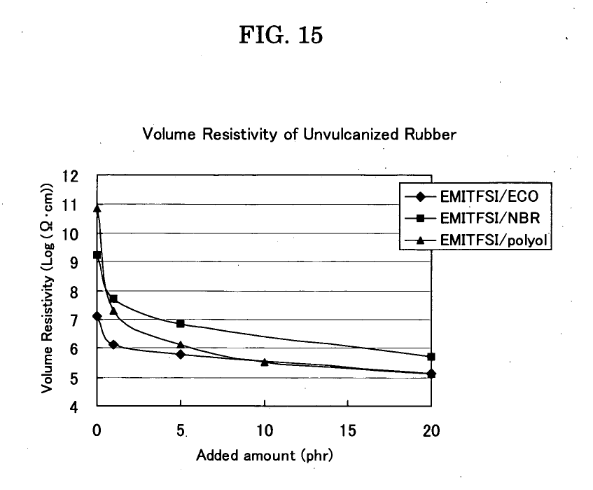

The results are shown in FIG. 15.

As is clear from FIG. 15, when the ionic liquid is added to the rubber base, the resultant rubber composition exhibits electrical conductivity, and when the ionic liquid is added to the polyol, the resultant polyol composition exhibits electrical conductivity. As is also clear from FIG. 15, in the rubber compositions of the Examples of the invention, which were prepared by adding the ionic liquid to the unvulcanized rubber base, the volume resistivity (logarithmic value) gradually decreases in accordance with an increase in the amount of the ionic liquid, and thus a target resistance can be readily attained.

In conclusion, even when the base is unvulcanized, addition of only a small amount of the ionic liquid is effective for reducing the resistance of the resultant rubber composition, and moreover, a target resistance can be readily attained. In addition, since the ionic liquid exhibits good compatibility with the rubber base, bleeding of the ionic liquid does not occur. When the rubber or polyol composition exhibiting electrical conductivity is subjected to molding, the resultant molded rubber product exhibits electrical conductivity.

As described above, since the moderately resistive rubber composition or rubber member of the present invention contains an ionic liquid as an electrically conductive material, the rubber composition or rubber member relatively readily attains a predetermined resistance and undergoes no change in physical properties. In addition, the rubber composition or rubber member is not affected by changes in humidity, and is minimally affected by change in environmental conditions and voltage.

1. A moderately resistive rubber composition comprising an unvulcanized rubber base and at least one ionic liquid contained in the rubber base, the ionic liquid serving as an electrically conductive material.

2. The moderately resistive rubber composition according to claim 1, wherein the ionic liquid contains a cationic species selected from the group consisting of cationic species represented by the following formulas (1) through (4): 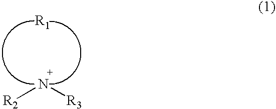
(wherein R₁ represents a C4-C10 hydrocarbon group; each of R₂ and R₃ represents a hydrogen atom, or a C1-C8 alkyl group; which R₁, R₂ or R₃ may contain a hetero atom; and, when the nitrogen atom has a double bond, R₃ is absent); 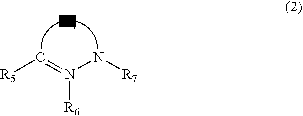
(wherein R₄ represents a C2-C10 hydrocarbon group, and each of R₅, R₆, and R₇ represents a hydrogen atom, or a C1-C8 alkyl group, which R₄, R₅, R₆ or R₇ may contain a hetero atom); 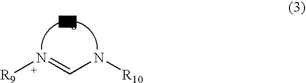
(wherein R₈ represents a C2-C10 hydrocarbon group, and each of R₉ and R₁₀ represents a hydrogen atom, or a C1-C8 alkyl group, which R₈, R₉, or R₁₀ may contain a hetero atom); and 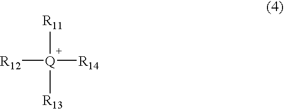
(wherein Q represents a nitrogen atom, a phosphorus atom, or a sulfur atom; each of R₁₁, R₁₂, R₁₃, and R₁₄ represents a hydrogen atom, or a C1-C8 alkyl group, which R₁₁, R₁₂, R₁₃ or R₁₄ may contain a hetero atom; and, when Q is a sulfur atom, R₁₁ is absent).

3. The moderately resistive rubber composition according to claim 1, wherein the ionic liquid contains an anionic species selected from among AlCl₄⁻, Al₂Cl₇⁻, NO₃⁻, BF₄⁻, PF₆⁻, CH₃COO⁻, CF₃COO⁻, CF₃SO₃⁻, (CF₃SO₂)₂N⁻, (CF₃SO₂)₃C⁻, AsF₆⁻, SbF₆⁻, F(HF)ₙ⁻, CF₃CF₂CF₂CF₂SO₃⁻, (CF₃CF₂SO₂)₂N⁻, and CF₃CF₂CF₂COO⁻.

4. The moderately resistive rubber composition according to claim 1, wherein the ionic liquid has a melting point of 70° C. or less.

5. The moderately resistive rubber composition according to claim 1, which has a volume resistivity of 1×10³ to 1×10⁹ Ω·cm.

6. A moderately resistive rubber member comprising a rubber-like elastic material formed through vulcanization of a moderately resistive rubber composition as recited in any one of claims 1 through 5.
